(19) United States
(12) Patent Application Publication
(10) Pub. No.: US 2009/0158975 A1
(43) Pub. Date: Jun. 25, 2009

(54) DEVICE FOR SECURING A FURNACE PROVIDED WITH A RAPID COOLING AND HEATING SYSTEM OPERATING UNDER CONTROLLED ATMOSPHERE

(75) Inventors: Xavier Cluzel, Paris (FR); Christian Gaillard, Maisons Alfort (FR); Gérard Jodet, La Flotte En Re (FR); Frederic Marmonier, Vaucresson (FR)

Correspondence Address: CONNOLLY BOVE LODGE & HUTZ LLP, 1875 EYE STREET, N.W., SUITE 1100, WASHINGTON, DC, 20006, US

(73) Assignee: FIVES STEIN, Ris Orangis (FR)

(21) Appl. No.: 12/300,574

(22) PCT Filed: Jun. 26, 2007
(86) PCT No.: PCT/FR07/01059

§ 371 Date: Feb. 27, 2009

(30) Foreign Application Priority Data
Jun. 30, 2006 (FR) 06 05932

(51) Int. Cl. F23N 5/24; G05D 23/00; F24F 7/007

(52) U.S. Cl. 110/193; 236/15 R; 236/49.3

(57) ABSTRACT

A device enabling limitation of the risk of formation of an explosive atmosphere in the furnace of a continuous heat treatment line of metal strips the sections of which are under an atmosphere consisting of a mixture of inert gas and hydrogen the hydrogen volume content of which is between 5 and 100%, provided with a rapid induction heating section and a rapid cooling section comprising: a chamber (9) maintained under inert gas at the inlet of the rapid heating section of the furnace and at the outlet of the rapid cooling section, the pressure in the chamber (9) being equal to or greater than the atmospheric pressure when the heating of the furnace operates normally; a device (10) for entering the strip into the chamber (9), from the atmospheric air; a device (11) for atmosphere separation and for entering the strip in the heating section of the furnace from the chamber (9) under inert gas, said device (11) being provided with a gas take-off (4); a device (13) for atmosphere separation and for removing the strip from the rapid cooling section of the furnace, provided with a gas take-off (14), and device (12) for removing the strip from the chamber (9) towards the atmospheric air.

The present invention relates to improvements made to the sections of continuous metal strip heat treatment lines equipped with rapid heating and cooling sections.

The expression “rapid heating and cooling” is understood to mean heating or cooling with a temperature gradient of 100° C./s or higher.

The object of the invention is most particularly to reduce the risk of forming an explosive atmosphere in the sections of the line in which an atmosphere consisting of a mixture of inert gas, generally nitrogen, and hydrogen is present.

To properly situate the technical field to which the present invention applies, reference is firstly made to FIG. 1 of the appended drawings, which show schematically a known example of a continuous metal strip heat treatment line equipped with rapid heating and cooling sections according to the prior art.

FIG. 1 shows a strip 1 running through a furnace 2 in which there is a protective atmosphere, the strip passing over several deflector rollers 3. The furnace is sealed by an inlet device 7 and an outlet device 8. As the strip 1 runs through the furnace 2, it is exposed in succession to heating means 5 and cooling means 6 positioned on either side of the strip.

The protective atmosphere present in the furnace is intended to prevent the strip from being oxidized during the high-temperature heating/cooling cycle. The atmosphere generally consists of a mixture of inert gas, particularly nitrogen, and hydrogen, the reducing character of this atmosphere enabling any oxides present on the surface of the strip to be reduced. The hydrogen content is greater than or equal to 4%. An atmosphere having a high hydrogen content, often containing between 20% and 75% hydrogen, is used on many continuous lines in the cooling sections so as to increase the performance of the convective cooling. In bright annealing lines for stainless steel strip, a hydrogen content up to 95% is used to obtain the required surface properties.

The pressure in the furnace is above atmospheric pressure so as to prevent any ingress of air, more precisely oxygen ingress, into the furnace. The presence of oxygen in the furnace has to be excluded for safety reasons so as to avoid any risk of forming an explosive atmosphere. The presence of oxygen is also to be excluded for surface quality reasons, since oxygen can form oxides on the strip.

The inlet device 7 and the outlet device 8 enable the open inlet and outlet sections of the furnace to be limited so as to reduce the leakage rate and therefore the consumption of atmosphere by the furnace. These devices are generally lock-chambers with rollers or flaps. Since these devices provide only relative sealing, the pressure in the furnace must be as low as possible so as to limit the amount of atmosphere gas escaping to the outside of the furnace near these devices and to reduce the consumption of atmosphere by the furnace.

By having the pressure in the furnace above atmospheric pressure, it is also possible to alleviate the variations in pressure due to atmosphere contractions during changes in strip format, changes in thermal cycles or changes in line speed, or in the event of incidents such as, for example, an emergency shutdown or a strip breakage. If the furnace were to be under reduced pressure, air would enter the furnace via the inlet device 7 and the outlet device 8. The presence of oxygen in the atmosphere having a high hydrogen content of the furnace would entail a high risk of forming an explosive atmosphere in the furnace. The simultaneous presence of an explosive atmosphere and explosion ignition points, which the hot spots in the furnace, even if only on the strip, represent, increases the risk of an explosion.

In a conventional furnace provided with an electrical resistance heating section or with combustion equipment, such as naked-flame burners or radiant gas tubes, the large volume of the heating section and its high thermal capacity act as a buffer and prevent the furnace from going into underpressure.

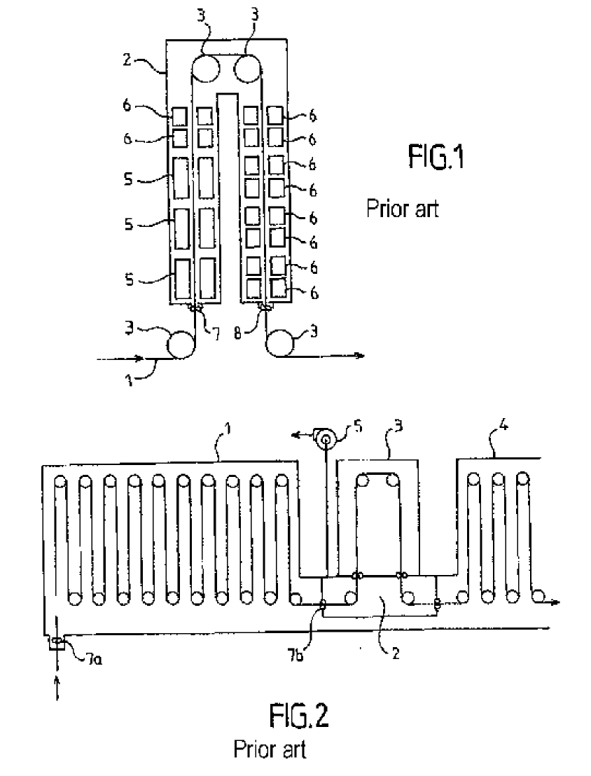

In an example of a conventional furnace produced according to the prior art, as shown in FIG. 2 extracted from the Applicant's patent FR 2 809 418, a section 2 separates the atmosphere between the heating section 1 having a low hydrogen content and the rapid cooling section 3 having a high hydrogen content. A takeoff 5 produced in the section 2 enables this section to be maintained at a pressure slightly below that of the sections 1 and 3 so that the flow of atmosphere between these sections takes place from sections 1 and 3 to section 2. A large underpressure in the cooling section 3 following a contraction of its atmosphere results in the atmosphere flowing from the section 2 into the section 3 and in an underpressure in the section 2. The underpressure in the section 2 then results in the atmosphere flowing from the section 1 into the section 2. The large atmosphere volume contained in this section 1 enables the underpressure in the sections 2 and 3 to be compensated for while still maintaining a positive pressure in the furnace, thereby preventing air ingress and therefore the formation of an explosive atmosphere. Moreover, the large distance between the inlet device 7a via which the strip enters the furnace and the inlet device 7b via which the strip enters the section 2 helps to reduce the risk of air entering the section 3 having a high hydrogen content in the case of air entering the furnace via the device 7a.

In this example of a continuous line produced according to the prior art shown in FIG. 2, a section 4 having a low hydrogen content, for slow cooling or for soaking before the final cooling, is fitted downstream of the rapid cooling section 3 having a high hydrogen content. Just like the heating section 1, this section 4 acts as a buffer volume in the event of atmosphere contraction in the section 3.

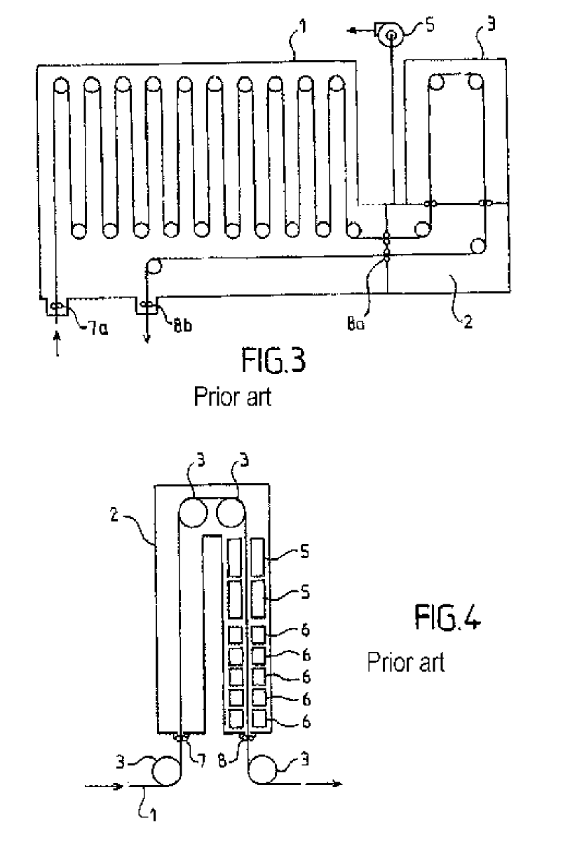

In another example of a continuous line produced according to the prior art, as shown in FIG. 3 extracted from the same patent FR 2 809 418, when the line does not include a section 4 downstream of the cooling section 3 having a high hydrogen content, the outlet device 8b via which the strip exits the furnace is placed on the heating section side so that it acts as a buffer volume and the distance between the devices 8a and 8b is large in order to reduce the risk of air entering the section 3 having a high hydrogen content in the case of air entering the furnace via the device 8b.

By having large buffer volumes in the lines shown in FIGS. 2 and 3 it is possible to limit the relative pressure (i.e. relative to atmospheric pressure) in the furnace to about 20 daPa without the risk of creating an underpressure in the event of atmosphere contraction in the cooling section.

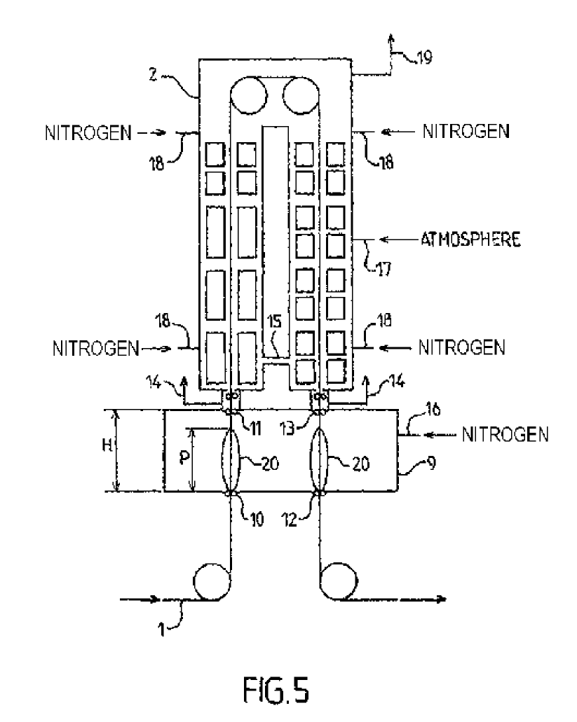

In the case of stainless steel bright annealing lines produced according to the prior art, the furnace configuration is as shown in FIG. 4.

FIG. 4 shows that the strip 1 runs through the furnace 2 in which there is a protective atmosphere having a high hydrogen content, typically 95%, the strip passing over several deflector rollers 3. The furnace is sealed by an inlet device 7 and an outlet device 8. While the strip 1 runs through the furnace 2, it is exposed in succession to heating means 5 and cooling means 6 positioned on either side of the strip. Stainless steel bright annealing requires the strip to be heated and cooled within the same vertical branch so as to avoid any contact of the strip with the rollers above a certain strip temperature prejudicial to the required surface quality. In this embodiment, the heating and cooling means are placed in the descending branch, while in another embodiment they would be placed in the ascending branch.

The bright annealing lines produced according to the prior art are generally equipped with radiative heaters 5 consisting of molded resistance heating elements. Owing to the constraint of fitting them only in one vertical branch and because of the limited maximum height of this branch in order to be compatible with the strength of the strip at the annealing temperature, the low power density of the molded resistance heating elements results in low-capacity lines running at low speeds.

Unlike the lines described in FIGS. 2 and 3, the bright annealing lines produced according to the prior art do not have buffer volumes having a low H₂ content in order to compensate for any contraction of the atmosphere as a result of a strip breakage. However, the high thermal inertia of the heating means employed and the low production capacity of the line mean that atmosphere contraction is reduced. To limit the risk of air entering the furnace, the relative pressure in the furnace is thus simply raised in bright annealing lines to about 60 to 70 daPa.

It will now be explained why the solutions employed for limiting the risk of forming an explosive atmosphere in conventional lines equipped with “slow” heating means are unsuitable for furnaces equipped with rapid heating and cooling means, i.e. those operating with temperature gradients (positive or negative) as a function of time equal to or greater than 100° C./s in absolute value.

A furnace for a continuous metal strip heat treatment line equipped with a rapid heating section, for example with a longitudinal-flow or transverse-flow induction heating unit, is, for the same line capacity, smaller in size in comparison with a furnace having a heating section equipped with electrical resistance heating elements or with combustion equipment such as naked-flame burners or radiant gas tubes. The volume of the N₂/H₂ atmosphere contained in an induction heating section is therefore much smaller than that contained in a conventional heating section. This small volume of atmosphere prevents it from acting as a buffer volume in the event of atmosphere contraction, as in a conventional furnace.

Moreover, the environment of the induction heating sections is “cool” in comparison with the conventional heating sections in which radiative or convective exchange requires high-temperature environments. Likewise, an induction heating section is characterized by a very low thermal inertia, the starting and stopping of the heating being practically instantaneous. In comparison, the conventional heating sections have a high thermal inertia owing to the large mass of materials raised to high temperature and therefore owing to the time needed to raise the temperature of the heating equipment upon starting the furnace or upon cooling them in the event of stopping the furnace. Consequently, unlike the conventional heating sections, the rapid induction heating section supplies just a little heat after stopping the heating in order to counteract the cooling of the atmosphere in the rapid cooling section and limit the level of underpressure reached in the furnace.

High-capacity continuous metal strip heat treatment lines have a high strip run speed, for example from 100 to 800 m/min, with high installed heating power levels, generally of several megawatts. To allow the strip to be rapidly cooled, these lines are equipped with rapid convective cooling sections in an atmosphere consisting of a nitrogen/hydrogen mixture rich in hydrogen, for example containing 30 to 100% hydrogen. These cooling sections are equipped with motor-driven centrifugal fans for blowing the gas through cooling boxes. After exchange with the strip, the hot gas is recirculated into the intake of the fan, being cooled through a water exchanger before again being blown onto the strip. The high performance of the cooling sections and the high production capacity of these lines require a large volume of atmosphere to be blown onto the strip, hence the use of high-power motor-driven fans operating at generally high nominal impeller rotation speeds.

In a high-capacity line with induction heating, a sudden stoppage in the heating, for example as a result of a strip breakage or an emergency stop, results in the supply of heat to the strip being suppressed almost instantaneously. The fans are stopped as soon as the line control system detects that the strip has stopped running or that the heating has stopped. However, because of their mechanical inertia, stopping the motor-driven fans requires several minutes. The delay that exists between stopping the induction heating almost instantaneously and stopping the cooling results in very rapid cooling of the flow of H₂/N₂ atmosphere circulating in the cooling circuits, since the power exchanged in the water exchangers remains equivalent to that provided by the induction heating. The very rapid cooling of the atmosphere just after the heating has been stopped results in a very considerable contraction of the atmosphere. This causes the cooling section, and also almost instantly the entire furnace, to go into great underpressure.

The time that elapses between the furnace being put into underpressure by a sudden stoppage of the heating and the instant when the pressure in the furnace returns to the atmospheric pressure value will be denoted by T.

Moreover, in the case of continuous lines equipped with rapid induction heating and rapid cooling sections, the level of underpressure reached in the furnace is accentuated by the combination of:
a low furnace volume due to the compactness of the induction heating section compared with the conventional heating sections using electrical resistance heating elements or combustion equipment;
a “cool” heating section supplying only a little heat after the heating has stopped in order to counteract the cooling of the atmosphere in the cooling section;
a high flow rate of recirculated atmosphere into the cooling section through water exchangers in order to obtain the required exchange capacity, hence very rapid cooling of the small atmosphere volume of the furnace; and
a high installed thermal power owing to the large tonnage of the line, hence a high refrigeration capability available for very rapidly cooling the small volume of atmosphere in the furnace when the induction heating suddenly stops.

In continuous metal strip heat treatment lines equipped with rapid induction heating and rapid cooling sections, the relative underpressure obtained just after the heating stops could thus reach a very high level. The increase in the nominal operating pressure of the furnace, which would be required in order to compensate for this underpressure and to prevent the furnace from going into underpressure, cannot be achieved on an industrial plant because of the large atmosphere leakage that it would cause at the inlet device and the outlet device, hence a substantial risk of forming a large volume of explosive atmosphere outside the furnace near these devices and an excessive consumption of atmosphere resulting in an increase in production cost of the line, which may possibly compromise the profitability of the installation.

A high-capacity induction furnace equipped with a rapid cooling section having a high hydrogen content therefore very greatly increases the risk of the atmosphere in the furnace exploding in the event of a sudden stoppage of the line compared with a conventional line equipped with a large heating section fitted with electrical resistance heating elements or with combustion equipment.

The invention provides a solution to this technical problem so as to limit the risk of forming an explosive atmosphere in the furnace.

According to the invention, a system for limiting the risk of forming an explosive atmosphere in the furnace of a continuous metal strip heat treatment line, the sections of which are under an atmosphere consisting of a mixture of inert gas and hydrogen, the hydrogen content of which is between 5 and 100% by volume, said system being equipped with a rapid induction heating section and a rapid cooling section, is characterized in that it comprises:
a chamber maintained under inert gas, at the inlet of the rapid heating section of the furnace and at the outlet of the rapid cooling section, the pressure in the chamber being above atmospheric pressure when the heating of the furnace is operating normally;
an inlet device at which the strip enters the chamber from the atmospheric air;
the atmosphere-separating inlet device via which the strip enters the heating section of the furnace from the chamber under inert gas, this device being fitted with a gas take-off;
an atmosphere-separating outlet device via which the strip exits the rapid cooling section of the furnace, this device being fitted with a gas take-off; and
an outlet device via which the strip exits the chamber into the atmospheric air.

Preferably, the relative pressure in the chamber maintained under inert gas, when the heating of the furnace is operating normally, is at least 20 daPa. The pressure in the chamber is generally equal to or slightly greater than the gas pressure in the furnace, for example by 2 daPa greater.

The inert gas may be nitrogen.

Preferably, the distance between the inlet device via which the strip enters the chamber and the atmosphere-separating inlet device via which the strip enters the rapid heating section of the furnace on the one hand, and between the atmosphere-separating outlet device via which the strip exits the rapid cooling section of the furnace and the outlet device via which the strip exits the chamber on the other, is greater than the length of the air plume created in the chamber in the event of underpressure in the furnace caused by the heating suddenly stopping. Advantageously, the length at a given instant of the air plume created in the chamber is chosen to be the length along the axis of the plume of the envelope defined by an air isoconcentration in the inert gas equal to that which would correspond to the UEL (upper explosion limit) if a mixture of air and the atmosphere (inert gas+H₂) were to be present in the furnace.

The volume of the chamber is preferably equal to or greater than the volume for which the flow rate of incoming air up to the instant when the pressure in the furnace again becomes equal to atmospheric pressure would result in an air concentration in the inert gas in this volume equal to that which would correspond to the UEL if a mixture of air and the atmosphere (inert gas+H₂) were to be present in the furnace.

The devices intended for separating the atmosphere between the furnace and the chamber comprise two sets of two rollers or flaps located on either side of the strip and the atmosphere is extracted at the take-off between the two sets of rollers and/or flaps in such a way that the atmosphere flows from the furnace to the take-off and flows from the chamber to the take-off without any exchange of atmosphere between the furnace and the chamber.

Preferably, the inlet and outlet devices and the atmosphere-separating devices are at the same height so that the gas pressures upstream and downstream of these devices are identical.

A linking tunnel may be provided in the lower part of the furnace between the ascending branch of the furnace and the descending branch so as to bring the atmosphere of the ascending and descending branches into communication with each other in the lower part of the furnace in order to help to balance the pressures and reduce the offtake rate required at the atmosphere-separating devices.

One or more points for injecting nitrogen into the chamber and one or more points for injecting inert gas, especially nitrogen, into the furnace are provided.

The device may comprise a succession of several chambers with atmosphere-separating devices between each of these chambers.

The device may comprise two separate chambers, one at the furnace inlet and the other at the furnace outlet.

The invention also relates to a method for limiting the risk of forming an explosive atmosphere in the furnace of a continuous metal strip heat treatment line, the sections of which are under an atmosphere consisting of a mixture of inert gas and hydrogen, the hydrogen content of which is between 5 and 100% by volume, said system being equipped with a rapid induction heating section and a rapid cooling section, this method being characterized by the implementation, as soon as a break in the strip or a rapid stoppage of the heating is detected, of a set of countermeasures for limiting the cooling of the atmosphere present in the furnace, these countermeasures comprising injection of inert gas, particularly nitrogen, at several points into the furnace and the chamber, and/or a cooling exchanger by-pass circuit and/or a device for stopping the recirculation flow from the fans, especially a control for shutting off the valves or flaps, or an electrical brake via a frequency regulator on the supply for the motor of the fans.

The invention consists, apart from the arrangements presented above, of a number of other arrangements which will be explained in greater detail below with regard to embodiments described with reference to the appended drawings, although these are in no way limiting. In these drawings:

FIG. 1 is a schematic vertical sectional view of a furnace according to the prior art;

FIG. 2 is a schematic vertical sectional view of an alternative embodiment of a furnace according to the prior art;

FIG. 3 is a schematic vertical sectional view of another alternative embodiment of a furnace according to the prior art;

FIG. 4 is also a schematic vertical sectional view of a furnace according to the prior art;

FIG. 5 is a schematic vertical sectional view of an induction furnace according to the invention;

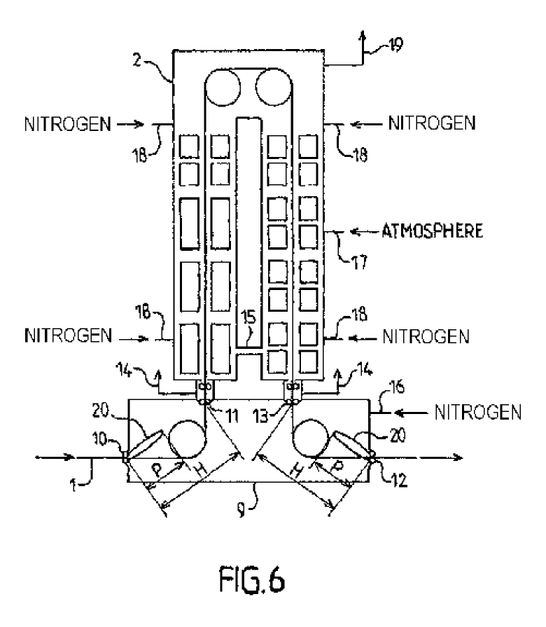

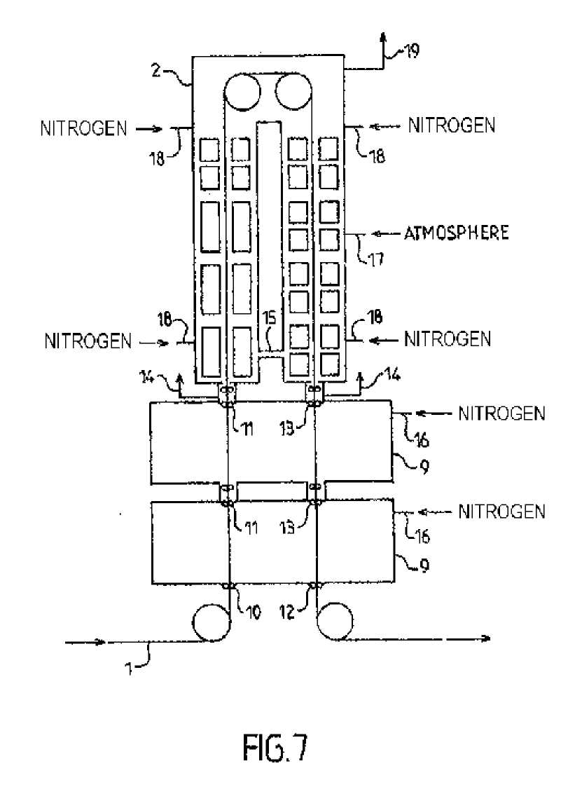

FIG. 6 is an alternative embodiment of an induction furnace according to the invention;

FIG. 7 is an alternative embodiment of an induction furnace according to the invention;

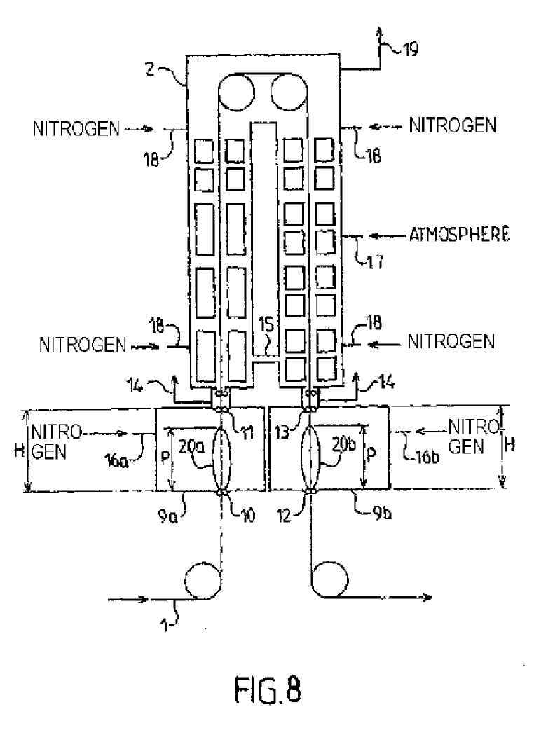

FIG. 8 is an alternative embodiment of an induction furnace according to the invention;

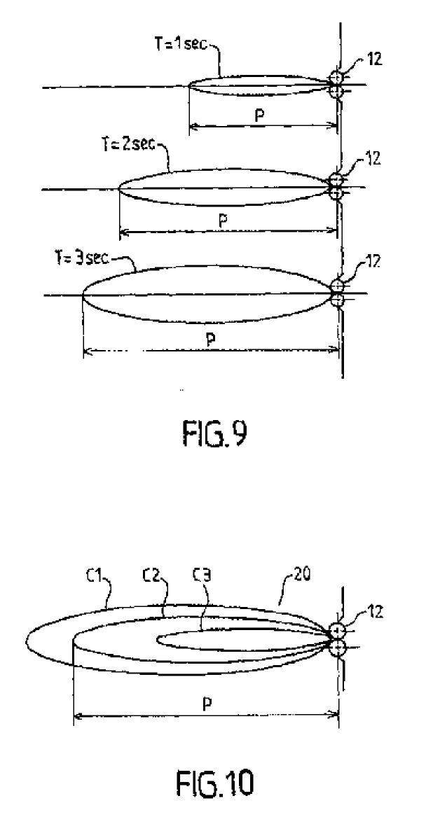

FIG. 9 illustrates three air plumes corresponding to successive instants; and

FIG. 10 illustrates successive air isoconcentration curves.

FIG. 5 of the drawings shows schematically one embodiment of the invention.

The invention provides a system for limiting the risk of forming an explosive atmosphere in the furnace of a continuous metal strip heat treatment line, the sections of which are under an atmosphere consisting of a mixture of inert gas, in particular nitrogen, and hydrogen, the hydrogen content of which is between 5 and 100% by volume, said system being equipped with a rapid induction heating section and a rapid cooling section, characterized in that it comprises:
a chamber 9 maintained under nitrogen, at a pressure above atmospheric pressure, especially at a relative pressure of at least 20 daPa;
an inlet device 10 at which the strip enters the chamber 9 from the atmospheric air;
an atmosphere-separating inlet device 11 via which the strip enters the furnace 2, this device being fitted with a take-off 14;
an atmosphere-separating outlet device 13 via which the strip exits the furnace 2, this device being fitted with a take-off 14; and
an outlet device 12 via which the strip exits the chamber 9 into the atmospheric air.

The system according to the invention is also characterized in that the distance H between the devices 10 and 11 on the one hand, and between the devices 12 and 13 on the other, is greater than the length P of the air plume 20 created in the chamber 9 in the event of an underpressure in the furnace caused by a sudden stoppage of the heating.

According to the invention, the length P at the instant T of the air plume 20 created in the chamber 9 is characterized as being the length along the axis of the plume of the envelope defined by an air isoconcentration in the nitrogen equal to that which would correspond to the UEL (upper explosion limit) if a mixture of air and the inert gas atmosphere (N₂/H₂) were to be present in the furnace. In other words the air concentration in the nitrogen within this envelope of the plume 20 is above said limit, whereas the air concentration in the nitrogen around this envelope of the plume 20 has not yet reached this limit.

The system according to the invention is also characterized in that the volume of the chamber 9 is equal to or greater than the volume V for which, in the event of heating of the furnace suddenly stopping, the flow rate of incoming air up to the instant T would result in an air concentration in the nitrogen in this volume equal to that which would correspond to the UEL if a mixture of air and the inert gas atmosphere (N₂/H₂) were to be present in the furnace.

The devices 11 and 13 are intended for separating the atmosphere between the furnace having a high hydrogen content and the chamber 9 under nitrogen. According to one embodiment of the invention, said devices consist of two sets of two rollers located on either side of the strip. According to another embodiment of the invention, they consist of two sets of rollers and/or flaps. The atmosphere is extracted at the take-off between the two sets of rollers and/or flaps in such a way that the atmosphere flows from the furnace 2 to the take-off 14 and flows from the chamber 9 to the take-off 14 without any atmosphere exchange between the furnace 2 and the chamber 9. The pressure in the furnace 2 and that in the chamber 9 are kept very similar so as to limit the extraction rate at the take-off 14 and therefore the amount of atmosphere top-up at 17 necessary to maintain the furnace 2 at its pressure level and the top-up with nitrogen at 16 in order to maintain the chamber 9 at its pressure level. The pressure in the chamber 9, while the heating of the furnace is operating normally, is preferably equal to or slightly above the pressure in the furnace. When the heating suddenly stops, the furnace goes into underpressure. This results in the underpressure, in the chamber 9, relative to atmospheric pressure, of the inert gas, particularly nitrogen, which flows from the chamber 9 into the furnace 2.

The devices 10, 12 and 11, 13 according to the invention are fitted in such a way that the respective devices 10 and 12 and the devices 11 and 13 are at the same height so that the gas pressures upstream and downstream of these devices are the same so as to prevent gas circulation by the chimney effect or a difference in the gas column weight.

Moreover, the invention includes a linking tunnel 15, in the lower part of the furnace, between the ascending branch and the descending branch of the furnace so as to bring the atmosphere of the ascending and descending branches into communication with each other in the lower part of the furnace in order to help to balance the pressures and reduce the offtake rate required at the devices 11 and 13.

Again, for the purpose of limiting the level of underpressure reached in the furnace and to limit the period of time T during which the furnace is in underpressure, the invention also consists of a method for limiting the risk of forming an explosive atmosphere in the furnace of a continuous metal strip heat treatment line, the sections of which are under an atmosphere consisting of a mixture of inert gas, particularly nitrogen, and hydrogen, the hydrogen content of which is between 5 and 100% by volume, the furnace being equipped with a rapid induction heating section and a rapid cooling section, characterized by the implementation, as soon as a strip breakage or a rapid stoppage of the heating is detected, of a set of countermeasures for limiting the cooling of the atmosphere present in the furnace, these counter measures comprising an injection of inert gas, particularly nitrogen, at several points into the furnace 2 and the chamber 9, and/or a cooling exchanger by-pass circuit and/or a device for stopping the recirculation flow from the fans.

The device for stopping the recirculation flow from the fans may consist of a control for shutting off valves or flaps or may consist of an electrical brake via a frequency regulator on the supply for the motor of the fans.

The invention provides one or more points 16 for injecting nitrogen into the chamber 9 and one or more points 18 for injecting nitrogen into the furnace 2. One or more exhaust points 19, fitted with a device that opens under excess pressure, prevent the pressure in the furnace from exceeding its nominal service value. These are for example placed in the upper part of the furnace.

According to the preferred embodiment of the invention for stainless steel bright annealing lines, the distance H is limited to that needed in order to be equal to the length P of the plume in such a way as to limit the height of the hottest point of the strip in the furnace. The volume of the chamber 9 is obtained by increasing the width and/or the length of the chamber.

According to another embodiment of the invention shown in FIG. 6, the entry and exit of the strip take place on the sides of the chamber 9.

According to another embodiment of the invention shown in FIG. 7, the chamber 9 is replaced with a succession of several, two or more, chambers 9 in series maintained under nitrogen, with atmosphere-separating devices 11 and 13 between each of these chambers.

According to another embodiment of the invention shown in FIG. 8, the chamber 9 is replaced by two chambers 9a, 9b, one placed at the inlet of the furnace and the other at the outlet of the furnace.

It will now be briefly described how the length P of the air plume in the chamber 9 is determined. The length P is governed by the laws governing the physics of jets.

In the embodiment of the invention shown in FIG. 5, there is a flat air jet immersed in nitrogen. This turbulent flat jet propagates and is diluted in the nitrogen, i.e. the velocity of the jet and its air concentration decrease upon going away from the inlet slot of the device 10 or of the device 12. As shown in FIG. 9, the development of the plume is unsteady. The length P increases with the time T during which the furnace is in underpressure.

The length P may be determined from a computational fluid dynamics model. Starting with a computed geometry and underpressure, the velocity and concentration fields are computed throughout the entire volume of the chamber and over the course of time. The length H may be modified according to the results, especially according to the air concentration at the inlet of the chamber under a high H₂ content.

The length P is computed for the plume developing from the inlet device 10 since, because of the drag due to the run speed of the strip, this plume will be longer than that generated at the outlet device 12, where the strip is running in the opposite direction to the development of the plume.

The propagation of the plume in the nitrogen has to be taken into account. As long as the plume generated in the device 10 has not reached the device 11, no amount of air can enter the furnace under hydrogen. The risk of forming an explosive atmosphere is therefore zero.

If the rate of propagation of the plume is W, then the length Pₘₐₓ of the plume such that no amount of air can enter the device 11 at the instant T when the furnace is in underpressure is equal to T×W. This length Pₘₐₓ may be considered to be an overly safe criterion since diffusion means that, even if the plume propagated as far as the device 11, the air concentration in the plume entering the zone under hydrogen would remain low and therefore in the end the air concentration in the N₂/H₂ mixture would not be hazardous.

According to the invention, the length P at the instant T is defined as being the length, along the axis of the plume, of the envelope defined by an air isoconcentration in the nitrogen equal to that which would correspond to the UEL if a mixture of air and the N₂/H₂ atmosphere were to be present in the furnace.

As shown in FIG. 10, the plume 20 consists of a succession of air isoconcentrations in nitrogen. Curves C1, C2 and C3 are representations of three air isoconcentrations in nitrogen, the C3 concentration being higher than the C2 concentration, which in turn is higher than the C1 concentration. The length P according to the invention is for example that on the axis of the plume of the envelope defined by the isoconcentration C2.

To guarantee good diffusion of the air plume into N₂ during the time T in which the chamber 9 is in underpressure, the volume V of the chamber must be high enough for this nitrogen volume to be replenished only very slightly with air for the duration of the underpressure.

The volume of the chamber 9 according to the invention is equal to or greater than the volume V for which the flow rate of incoming air at the instant T would result in an air concentration in the nitrogen in this volume equal to that which would correspond to the UEL if a mixture of air and the N₂/H₂ atmosphere were present in the furnace.

The volume flow rate Q of air entering via the devices 10 and 12 depends on the pressure drop coefficient ξ of these devices and on the outputting area S at the devices. It is expressed, based on equation (A), where U is the velocity of the air entering via the devices 10 and 12:

$$U = \sqrt{\frac{2 Δ P}{{ρ}_{air} ξ}} , \\ namely Q = U \times S . \qquad ( A )$$

The incoming flow rate therefore depends on the pressure difference ΔP between atmospheric pressure and the pressure inside the chamber 9. The term ρₐᵢᵣ denotes the density of the air. The variation over the course of time of the pressure in the chamber must be evaluated so as to determine the instantaneous flow rate of the incoming air and the variation in the overall air concentration in the volume V.

The variation in the overall pressure in the chamber 9 and the furnace may be estimated using a transient model which, at each instant, performs a mass balance in the chamber 9 and the furnace (between incoming nitrogen flow rate and outgoing gaseous flow rate) and an enthalpy balance, enabling the temperature of the volume of gas in the chamber 9 and of the furnace to be known. The pressure is calculated from these conditions, namely the mass flow rate and the temperature. The countermeasures taken into account by the model are for example:
the by-pass circuit is taken into account in the enthalpy balance, by means of the flow rate of fresh gas reinjected into the volume;
the nitrogen purge volume is taken into account in the mass balance.

The air concentration in the nitrogen in the chamber 9 may be defined using various methods of calculation. To give an example, a conventional method used in process engineering for a perfectly stirred reactor in which the concentration is uniform throughout the volume is employed below.

The air concentration in the nitrogen is expressed by the equation (B) given below:

$${[ A ]}_{T} = {[ A ]}_{incoming} - ( {[ A ]}_{incoming} - {[ A ]}_{0} ) exp ( \frac{- T}{{t}_{geom}} ) \qquad ( B )$$

in which:
[A]_{T} is the volume concentration of air in the nitrogen in the chamber 9 at the instant T when the chamber 9 returns to pressure;
[A]_{incoming} is the air concentration in the incoming gas in the chamber 9 entering via the devices 10 and 12;
[A]₀ is the initial air concentration in the chamber 9 before it goes into underpressure; and
t_{geom} is the geometric time of the chamber 9, the geometric time t_{geom} being expressed by the equation (C) given below:

t_{geom}=V/Q (C)

in which:
V is the volume of the chamber 9; and
Q is the volume flow rate entering the chamber 9 via the devices 10 and 12.

Based on equations (A), (B) and (C) it is possible to determine the volume V of the chamber 9 as a function of the air concentration in the nitrogen in the chamber.

The air concentration [A]_{T} in the nitrogen in the chamber 9 adopted for determining the dimensions of the volume of the chamber 9 is for example the air concentration that would correspond to the UEL if a mixture of air and the N₂/H₂ atmosphere were to be present in the furnace. Thus, this would be 0.3 (30% air) if there were an N₂/H₂ atmosphere containing 95% H₂ by volume. The values of [A]_{incoming} and [A]₀ would be 1.0 (100% air) and 0.0 (100% nitrogen) respectively. The calculation is performed for example for the pressure difference ΔP between atmospheric pressure and the highest pressure reached inside the chamber 9 while the chamber 9 is going into underpressure.

1. A system for limiting the risk of forming an explosive atmosphere in the furnace of a continuous metal strip heat treatment line, the sections of which are under an atmosphere consisting of a mixture of inert gas and hydrogen, the hydrogen content of which is between 5 and 100% by volume, said system being equipped with a rapid induction heating section and a rapid cooling section, wherein it comprises:
a chamber maintained under inert gas, at the inlet of the rapid heating section of the furnace and at the outlet of the rapid cooling section, the pressure in the chamber being above atmospheric pressure when the heating of the furnace is operating normally;
an inlet device at which the strip enters the chamber from the atmospheric air;
the atmosphere-separating inlet device via which the strip enters the heating section of the furnace from the chamber under inert gas, this device being fitted with a gas take-off;
an atmosphere-separating outlet device via which the strip exits the rapid cooling section of the furnace, this device being fitted with a gas take-off; and
an outlet device via which the strip exits the chamber into the atmospheric air.

2. The system as claimed in claim 1, wherein the relative pressure in the chamber maintained under inert gas, when the heating of the furnace is operating normally, is at least 20 daPa.

3. The system as claimed in claim 1, wherein the pressure in the chamber maintained under inert gas, when the heating of the furnace is operating normally, is equal to or greater than the gas pressure in the furnace.

4. The system as claimed in claim 1, wherein the inert gas is nitrogen.

5. The system as claimed in claim 1, wherein the distance (H) between the inlet device via which the strip enters the chamber and the atmosphere-separating inlet device via which the strip enters the rapid heating section of the furnace on the one hand, and between the atmosphere-separating outlet device via which the strip exits the rapid cooling section of the furnace and the outlet device via which the strip exits the chamber on the other, is greater than the length (P) of the air plume created in the chamber in the event of underpressure in the furnace caused by the heating suddenly stopping.

6. The system as claimed in claim 5, wherein the length (P) at a given instant of the air plume created in the chamber is chosen to be the length along the axis of the plume (C2) of the envelope defined by an air isoconcentration in the inert gas equal to that which would correspond to the UEL (upper explosion limit) if a mixture of air and the atmosphere (inert gas+H₂) were to be present in the furnace.

7. The system as claimed in claim 1, wherein the volume of the chamber is equal to or greater than the volume (V) for which the flow rate of incoming air up to the instant when the pressure in the furnace again becomes equal to atmospheric pressure would result in an air concentration in the inert gas in this volume equal to that which would correspond to the UEL if a mixture of air and the atmosphere (inert gas+H₂) were to be present in the furnace.

8. The system as claimed in claim 1, wherein the devices intended for separating the atmosphere between the furnace and the chamber comprise two sets of two rollers or flaps located on either side of the strip and in that the atmosphere is extracted at the take-off between the two sets of rollers and/or flaps in such a way that the atmosphere flows from the furnace to the take-off and flows from the chamber to the take-off without any exchange of atmosphere between the furnace and the chamber.

9. The system as claimed in claim 1, wherein the inlet and outlet devices and the atmosphere-separating devices are at the same height so that the gas pressures upstream and downstream of these devices are identical.

10. The system as claimed in claim 1, wherein a linking tunnel is provided in the lower part of the furnace between the ascending branch of the furnace and the descending branch so as to bring the atmosphere of the ascending and descending branches into communication with each other in the lower part of the furnace in order to help to balance the pressures and reduce the offtake rate required at the atmosphere-separating devices.

11. The system as claimed in claim 1, wherein one or more points for injecting nitrogen into the chamber and one or more points for injecting nitrogen into the furnace are provided.

12. The system as claimed in claim 1, wherein it includes a succession of several chambers in series with atmosphere-separating devices between each of these chambers.

13. The system as claimed in claim 1, wherein it comprises two chambers, one placed at the inlet of the furnace and the other at the outlet of the furnace.

14. The system as claimed in claim 1, making it possible to limit the level of underpressure reached in the furnace and the chamber and to limit the risk of forming an explosive atmosphere in the furnace, characterized by implementing an injection of inert gas, particularly nitrogen, at several points into the furnace and the chamber, and/or a cooling exchanger by-pass circuit and/or a device for stopping the recirculation flow from the fans as soon as a break in the strip or a rapid stoppage of the heating is detected.

15. The system as claimed in claim 14, wherein the device for stopping the recirculation flow from the fans comprises a control for shutting off the valves or flaps and/or an electrical brake via a frequency regulator on the supply for the motor of the fans.
